(19) United States
(12) Patent Application Publication
(10) Pub. No.: US 2023/0107414 A1
(43) Pub. Date: Apr. 6, 2023

(54) METHOD FOR CONTROLLING VIRTUAL OBJECT

(71) Applicant: Tencent Technology (Shenzhen) Company Limited, Shenzhen (CN)

(72) Inventors: Jue HU, Shenzhen (CN); Minghua CHEN, Shenzhen (CN); Han YANG, Shenzhen (CN); Chunlin ZHU, Shenzhen (CN); Long HAN, Shenzhen (CN); Zhaobo XU, Shenzhen (CN); Mingyang CHU, Shenzhen (CN)

(73) Assignee: Tencent Technology (Shenzhen) Company Limited, Shenzhen (CN)

(21) Appl. No.: 18/063,148

(22) Filed: Dec. 8, 2022

Related U.S. Application Data
(63) Continuation of application No. PCT/CN2022/090926, filed on May 5, 2022.

(30) Foreign Application Priority Data
Jun. 21, 2021 (CN) 202110687665.4

(51) Int. Cl. A63F 13/55; G06T 19/00; H04N 21/2187

(52) U.S. Cl. CPC A63F 13/55; G06T 19/00; H04N 21/2187

(57) ABSTRACT

This disclosure relates to a virtual object control method. The method includes: displaying, by an electronic device, a first live streaming resource, the first live streaming resource including at least one selectable virtual object and at least one virtual object controlled by an anchor user; transmitting a control request when receiving a selection instruction for a target virtual object in the at least one selectable virtual object, the control request being for requesting to control the target virtual object; and controlling, in response to a control instruction for the target virtual object, the target virtual object to perform a target operation. With the foregoing method, viewer users can participate in live streaming when watching the live streaming, thereby improving the level of participation of the viewer users, and increasing interaction between the viewer users and the anchor user.

### RELATED APPLICATION

This application is a continuation application of PCT Patent Application No. PCT/CN2022/090926, filed on May 5, 2022, which claims priority to Chinese Patent Application No. 202110687665.4, filed on Jun. 21, 2021 and entitled “VIRTUAL OBJECT CONTROL METHOD AND APPARATUS, DEVICE, SYSTEM, AND READABLE STORAGE MEDIUM,” wherein the content of the of the above-referenced applications is incorporated herein by reference in its entirety.

### FIELD OF THE TECHNOLOGY

Embodiments of this disclosure relate to the field of Internet technologies, and in particular, to a virtual object control method and apparatus, a device, a system, and a readable storage medium.

### BACKGROUND OF THE DISCLOSURE

With the continuous development of Internet technologies, an increasing number of users choose to watch game live streaming videos through game live streaming platforms.

In the related art, a game client and a live streaming client are installed and run in an electronic device of an anchor user, and the anchor user plays a game by calling the game client, and performs game live streaming by calling the live streaming client. During the game live streaming, the live streaming client obtains a video of the game picture of the anchor user, to form an audio and video stream, and pushes the audio and video stream to a content delivery network (CDN). When a viewer user intends to watch the anchor user's game live streaming video, the CDN pushes the anchor user's audio and video stream to an electronic device of the viewer user, and a video player installed in the electronic device of the viewer user plays the anchor user's game live streaming video.

However, the viewer user can only watch the anchor user's game live streaming video, and has relatively weak control on a virtual object in the game, which results in a relatively low rate of interaction between the viewer user and the anchor user and poor extensibility. Moreover, the control manner for the virtual object is relatively undiversified, and the flexibility is not high.

### SUMMARY

Embodiments of this disclosure provide a virtual object control method and apparatus, a device, a system, and a readable storage medium, which can be applied to resolve the problems of relatively weak control of viewer users on virtual objects, a relatively low rate of interaction between the viewer users and an anchor user, relatively undiversified and inflexible control manner for the virtual objects, and poor extensibility in the related art. The technical solutions are as follows:

According to an aspect, an embodiment of this disclosure provides a virtual object control method, performed by an electronic device, the method including:

displaying a first live streaming resource, the first live streaming resource comprising at least one selectable virtual object and at least one virtual object controlled by an anchor user; transmitting a control request in response to receiving a selection instruction for a target virtual object in the at least one selectable virtual object, the control request being for requesting to control the target virtual object; and controlling, in response to a control instruction for the target virtual object, the target virtual object to perform a target operation.

According to another aspect, an embodiment of this disclosure provides a virtual object control method, performed by a server, the method including:

receiving a control request transmitted by an electronic device, the control request carrying an object identifier of a target virtual object, the control request being for requesting to control the target virtual object, and the target virtual object being an selectable virtual object comprised in a first live streaming resource; obtaining an audio and video data stream address of the target virtual object based on the object identifier of the target virtual object; and transmitting the audio and video data stream address of the target virtual object to the electronic device.

According to another aspect, an embodiment of this disclosure provides an electronic device, including a processor and a memory, the memory storing at least one piece of program code, the at least one piece of program code being loaded and executed by the processor to cause the electronic device to implement the virtual object control method described in the first aspect.

According to another aspect, an embodiment of this disclosure provides a server, including a processor and a memory, the memory storing at least one piece of program code, the at least one piece of program code being loaded and executed by the processor to cause the server to implement the virtual object control method described in the second aspect.

According to another aspect, an embodiment of this disclosure provides a virtual object control system, including an electronic device and a server, the electronic device being configured to implement the virtual object control method described in the first aspect, and the server being configured to implement the virtual object control method described in the second aspect.

According to another aspect, a non-temporary computer-readable storage medium is further provided, the non-temporary computer-readable storage medium storing at least one piece of program code, the at least one piece of program code being loaded and executed by a processor to cause a computer to implement any one of the virtual object control methods described above.

According to another aspect, a computer program or computer program product is further provided, the computer program or computer program product storing at least one computer instruction, the at least one computer instruction being loaded and executed by a processor to cause a computer to implement any one of the virtual object control methods described above.

In the technical solutions provided in the embodiments of this disclosure, the first live streaming resource displayed by the electronic device includes selectable virtual objects, which improves the diversity of content displayed by the electronic device, so that viewer users can not only view the first live streaming resource, but also control controllable virtual objects in the first live streaming resource, thereby improving the level of participation and the level of activity of the viewer users, and making the interactivity between the viewer users and the anchor user of the first live streaming resource relatively high, and the control manners for virtual objects relatively plentiful and flexible. Further, the attractiveness of the first live streaming resource to the viewer users can be improved, and the competitiveness of the game corresponding to the first live streaming resource can be improved.

In addition, the local game can be turned into a multiplayer online game. That is, the electronic device displays the first live streaming resource including the selectable virtual objects, and realizes control on the target virtual object according to the received selection instruction and control instruction, to enable the viewer users to play the game with the anchor user, so that the local game of the anchor user becomes a multiplayer online game between the viewer users and the anchor user. Therefore, the implementation of playing a game based on electronic devices is enriched, the implementation cost of the implementation is lower than the implementation cost of a conventional multiplayer game, and the extensibility is relatively strong.

### BRIEF DESCRIPTION OF THE DRAWINGS

FIG. 1 is a schematic diagram of an implementation environment of a virtual object control method according to an embodiment of this disclosure.

FIG. 2 is a flowchart of a virtual object control method according to an embodiment of this disclosure.

FIG. 3 is a schematic diagram of display of a first live streaming resource according to an embodiment of this disclosure.

FIG. 4 is a schematic diagram of display of an selectable virtual object box according to an embodiment of this disclosure.

FIG. 5 is a schematic diagram of display of object information of a target virtual object according to an embodiment of this disclosure.

FIG. 6 is a schematic diagram of display of third prompt information according to an embodiment of this disclosure.

FIG. 7 is a schematic diagram of display of first prompt information according to an embodiment of this disclosure.

FIG. 8 is a schematic diagram of display of second prompt information according to an embodiment of this disclosure.

FIG. 9 is an architectural diagram of a virtual object control method according to an embodiment of this disclosure.

FIG. 10 is a flowchart of a virtual object control method according to an embodiment of this disclosure.

FIG. 11 is a flowchart of a virtual object control method according to an embodiment of this disclosure.

FIG. 12 is a flowchart of a virtual object control method according to an embodiment of this disclosure.

FIG. 13 is a schematic structural diagram of a virtual object control apparatus according to an embodiment of this disclosure.

FIG. 14 is a schematic structural diagram of a virtual object control apparatus according to an embodiment of this disclosure.

FIG. 15 is a schematic structural diagram of an electronic device according to an embodiment of this disclosure.

FIG. 16 is a schematic structural diagram of a server according to an embodiment of this disclosure.

### DESCRIPTION OF EMBODIMENTS

To make the objectives, technical solutions, and advantages of this disclosure clearer, the following further describes implementations of this disclosure in detail with reference to the accompanying drawings.

For convenience of understanding, several terms involved in the embodiments of this disclosure are first explained:

Virtual scene: It is a scene provided (or displayed) when an application is run on a terminal. The virtual scene refers to a scene created for a virtual object to perform activities. The virtual scene may be a two-dimensional virtual scene, a 2.5-dimensional virtual scene, or a three-dimensional virtual scene. The virtual scene may be a simulated scene of the real world, or may be a semi-simulated semi-fictional scene, or may be an entirely fictional scene. For example, the virtual scene in the embodiments of this disclosure is a three-dimensional virtual scene.

Virtual object: A virtual object is a movable object in a virtual scene. The movable object may be a virtual character, a virtual animal, or a cartoon character. An interaction object may control a virtual object by using a peripheral component or tapping a touch display screen. Each virtual object has a shape and a volume in the virtual scene, and occupies some space in the virtual scene. For example, when the virtual scene is a three-dimensional virtual scene, the virtual object is a three-dimensional model created based on a skeletal animation technology.

Cloud gaming, which may also be referred to as gaming on demand, is an online gaming technology based on the cloud computing technology. The cloud gaming technology enables thin clients with relatively limited graphics processing and data computing capabilities to run high-quality games. In a cloud game scene, the game is not run on a game terminal of a player, but in a cloud server, and the cloud server renders a game scene into video/audio streams, and transmits the video/audio streams to the game terminal of the player through a network. The game terminal of the player does not need to have strong graphics computing and data processing capabilities, but only needs to have the basic streaming media playback capability and the capability to obtain player input instructions and transmit the player input instructions to the cloud server.

Software development kits (SDKs) usually refer to some sets of development kits used by a software engineer for creating application software for a specified software package, a specified software framework, a specified hardware platform, a specified operating system, and the like. The SDK can intervene in any quantity of cameras and audio listeners in a game to capture the corresponding textures and audios to form audio and video push streams. A game data stream may include any type of game data, for example, information such as a character ID and a real-time position. The game data flow is one-way push stream. Game events support two-way communication between the game and the outside world. Various interaction behaviors between users and the game can be defined as events, including manipulation, voting, and the like. The SDK obtains data from the accessed cameras and audio listeners at the end of each period. The game data stream is also refreshed periodically, and different update and push frequencies of videos, audios, and game data may be set as required.

Live streaming platform: It is a platform for live streaming that provides a real-time push stream of an anchor to a viewer viewing end.

A video player refers to software that can play a video stored in a form of a digital signal, and also refers to an electronic device product with a video playback function. Most video players (except a few wave files) carry a decoder to restore compressed media files, and video players also have a full set of built-in frequency conversion and buffer algorithms.

Overlay: It refers to a floating layer for game interaction such as role playing that is displayed on the video player in a superimposition manner, and an SDK that provides this function is named Overlay SDK.

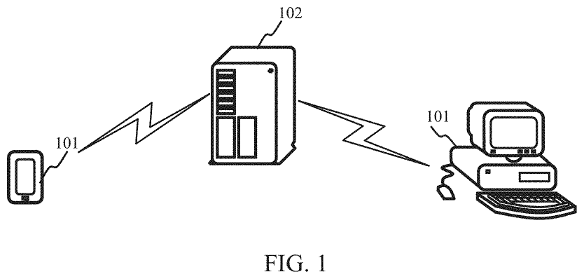

FIG. 1 is a schematic diagram of an implementation environment of a virtual object control method according to an embodiment of this disclosure. As shown in FIG. 1, the implementation environment includes an electronic device 101 and a server 102.

The electronic device 101 may be at least one of a smartphone, a game console, a desktop computer, a tablet computer, an ebook reader, a Moving Picture Experts Group Audio Layer III (MP3) player, a Moving Picture Experts Group Audio Layer IV (MP4) player, and a laptop portable computer. Electronic device 101 is configured to perform the virtual object control method provided in this embodiment of this disclosure. The server 102 may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The server 102 may be directly or indirectly connected to the electronic device 101 in a wired or wireless communication manner. This is not limited in this disclosure.

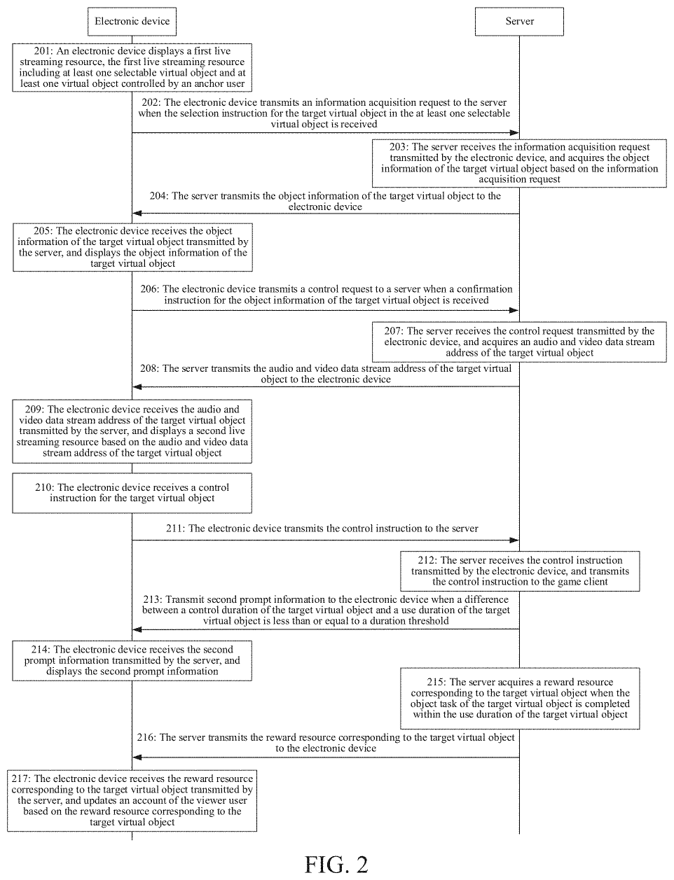

Based on the foregoing implementation environment, an embodiment of this disclosure provides a virtual object control method. The method may be implemented through interaction between the electronic device 101 and the server 102 in FIG. 1. The method is described by using the flowchart of a virtual object control method according to an embodiment of this disclosure shown in FIG. 2 as an example. As shown in FIG. 2, the method includes the following steps:

Step 201: An electronic device displays a first live streaming resource, the first live streaming resource including at least one selectable virtual object and at least one virtual object controlled by an anchor user.

In this embodiment of this disclosure, a first client is installed and run in the electronic device. The first client is a live streaming client and is configured for video live streaming or watching live streaming videos. The first client may be any type of client, and the type of the first client is not limited in this embodiment of this disclosure. An Overlay SDK is accessed to the first client.

In a possible implementation, a viewer user is logged in to the electronic device, and in response to a trigger operation on the first client in the electronic device by the viewer user, the homepage of the first client is displayed. A plurality of live streaming studios are displayed in the homepage of the first client, and there is one or more anchor users in each live streaming studio. In response to a selection instruction of the viewer user for any one of the plurality of live streaming studios, the electronic device determines the selected live streaming studio as the target live streaming studio. The electronic device transmits a live streaming resource acquisition request to a server, the live streaming resource acquisition request carrying a live streaming studio identifier of the target live streaming studio. The live streaming studio identifier may be a room number of the live streaming studio, an account of the anchor that opens the live streaming studio, or any other identifier that can uniquely represent the target live streaming studio. This is not limited in this embodiment of this disclosure.

The server receives the live streaming resource acquisition request, and parses the live streaming resource acquisition request to obtain the live streaming studio identifier of the target live streaming studio. The server obtains the first live streaming resource of the target live streaming studio based on the live streaming studio identifier of the target live streaming studio. The server returns the first live streaming resource of the target live streaming studio to the electronic device. For example, the server obtains the first live streaming resource from a game client based on the live streaming studio identifier of the target live streaming studio, the first live streaming resource being obtained by playing a game through the game client by the anchor user of the target live streaming studio. The game client is a game client in the cloud. In response to an anchor user control instruction, the electronic device of the anchor user of the target live streaming studio transmits the anchor user control instruction to the server. The server forwards the anchor user control instruction to the game client, so that the anchor user of the target live streaming studio can play the game through the game client. For example, the anchor user can control a virtual object. When the anchor user plays the game in the game client, an audio and video, for example, an audio and video corresponding to controlling the virtual object by the anchor user, can be formed. The audio and video may be associated with the live streaming studio identifier of the target live streaming studio in which the anchor user is located, so that the server can obtain the audio and video based on the live streaming studio identifier, and return the audio and video to the electronic device of the viewer user as the first live streaming resource. Certainly, the audio and video may alternatively be returned to the electronic device of the anchor user, and the electronic device of the anchor user calls a second client to display the audio and video.

The electronic device receives the first live streaming resource returned by the server, and the electronic device calls the first client to display the first live streaming resource. The first live streaming resource is the audio and video corresponding to the virtual object controlled by the anchor user. For example, the first live streaming resource is an audio and video obtained from the viewpoint of the virtual object controlled by the anchor user. A scene picture of the virtual scene in which the virtual object controlled by the anchor user is located is displayed in the first live streaming resource, and the first live streaming resource includes at least one virtual object controlled by the anchor user and at least one selectable virtual object. In some implementations, the selectable virtual object cannot be controlled by the anchor user, and the selectable virtual object is a virtual object controlled by AI. The selectable virtual object is a non-player character (NPC). In some other implementations, the selectable virtual object cannot be controlled by the anchor user. That is, the anchor user controls at least two virtual objects, and at least one of the at least two virtual objects is used as an selectable virtual object, and the control right of the selectable virtual object may be transferred from the anchor user to the viewer user. For example, regardless of whether the selectable virtual object is capable of being controlled by the anchor user or not, the selectable virtual object includes, but not limited to, virtual objects such as a game monster and a game prop. The type of the selectable virtual object is not limited in this embodiment of this disclosure.

For example, among the virtual objects included in the first live streaming resource, the selectable virtual object is variable. An example in which the first live streaming resource includes a virtual object A and a virtual object B is used, then the selectable virtual object may be the virtual object A first, and then change to the virtual object B. Factors that cause the change of the selectable virtual object is not limited in this embodiment of this disclosure. For example, the selectable virtual object changes based on time. For example, make the selectable virtual object be the virtual object A in the morning, and make the selectable virtual object be the virtual object B in the afternoon. In another example, the selectable virtual object changes according to settings of the anchor user. For example, when the anchor user sets the selectable virtual object to the virtual object A, make the selectable virtual object be the virtual object A. When the anchor user resets the selectable virtual object to the virtual object B, make the selectable virtual object change from the virtual object A to the virtual object B. In another example, the selectable virtual object changes according to the quantity of votes of viewer users. For example, w % ben the quantity of votes of the viewer users for the virtual object A is the largest, make the selectable virtual object be the virtual object A. After the quantity of votes of the viewer users for the virtual object B exceeds the quantity of votes of the viewer users for the virtual object A, the selectable virtual object changes from the virtual object A to the virtual object B.

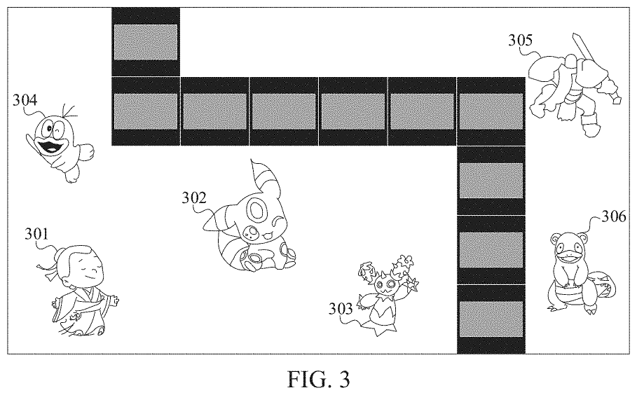

FIG. 3 is a schematic diagram of display of a first live streaming resource according to an embodiment of this disclosure. In FIG. 3, a virtual object 301 controlled by the anchor user, an selectable virtual object 302, an selectable virtual object 303, an selectable virtual object 304, an selectable virtual object 305, and an selectable virtual object 306 are displayed. In a possible implementation, because the size of a display interface of the electronic device is fixed, there may be a case that the first live streaming resource cannot be completely displayed, resulting in a situation that the selectable virtual resources included in the first live streaming resource cannot be completely displayed. For this situation, an selectable virtual object display control may be displayed on the display interface of the first live streaming resource, and in response to a trigger operation on the selectable virtual object display control by the viewer user, an selectable virtual object box is displayed on the display interface of the first live streaming resource, and all the selectable virtual objects are displayed in the selectable virtual object box. An selectable virtual resource box may be displayed on the first live streaming resource in a superimposition manner, or the display of the first live streaming resource may be canceled, and the selectable virtual resource box may be displayed. The display manner of the selectable virtual object box is not limited in this embodiment of this disclosure.

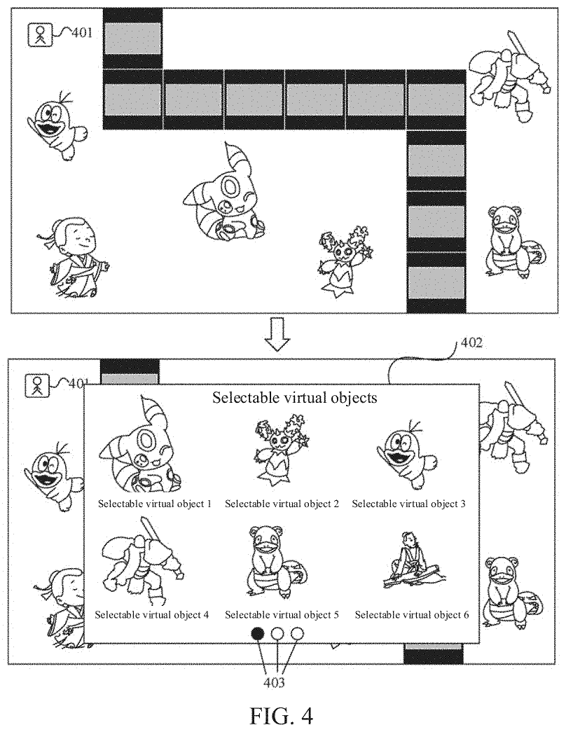

FIG. 4 is a schematic diagram of display of an selectable virtual object box according to an embodiment of this disclosure. In FIG. 4, an selectable virtual object box displayed on the first live streaming resource in a superimposition manner. In FIG. 4, an selectable virtual object display control 401 is displayed in the first live streaming resource. In response to a trigger operation on the selectable virtual object display control 401 by the viewer user, an selectable virtual object box 402 is displayed, and all the selectable virtual objects are displayed in the selectable virtual object box 402. The selectable virtual objects on the first page displayed in the selectable virtual object box 402 shown in FIG. 4 are respectively selectable virtual object 1 to selectable virtual object 6. When there are a relatively large quantity of selectable virtual objects and they cannot be completely displayed on one page in the selectable virtual object box, a page turning control 403 is further provided. The selectable virtual objects displayed on each page are different, and those displayed in FIG. 4 are the selectable virtual objects on the first page. When the page turning control is triggered, selectable virtual object on the second page are displayed.

In an exemplary implementation, the electronic device may further obtain a target rendering form, and display the first live streaming resource in the target rendering form during display of the first live streaming resource.

The process of obtaining the target rendering form is as follows: obtaining user information of a viewer user; obtaining preference information of the viewer user based on the user information of the viewer user, the viewer user including at least one of a user controlling the target virtual object and a user viewing the first live streaming resource; and obtaining a target rendering form based on the preference information of the viewer user. User information includes, but not limited to, information such as a user name, a user age, a user gender, and a type of an electronic device used by the user.

For example, the user information is the type of the electronic device used by the user. It is determined that the preference information of the viewer user is an electronic device with a specific type based on the user information, and then a cartoon image of the electronic device with the specific type is obtained. When the first live streaming resource is displayed, a certain virtual object in the first live streaming resource is replaced with the cartoon image of the electronic device with the specific type, thereby attracting the viewer user and improve the interest of the viewer user. In addition, electronic devices with the specific type can be promoted.

Step 202: The electronic device transmits an information acquisition request to the server when the selection instruction for the target virtual object in the at least one selectable virtual object is received.

In a possible implementation, the viewer user may view all the selectable virtual objects, and when the viewer user intends to control the target virtual object in the selectable virtual objects, the viewer user may select the target virtual object. The selection manner may be that the viewer user clicks the target virtual object, or the viewer user selects the target virtual object by voice. The selection manner is not limited in this embodiment of this disclosure. When the electronic device receives a selection instruction of the viewer user for the target virtual object, the electronic device transmits an information acquisition request to the server. The information acquisition request carries the object identifier of the target virtual object, and the object identifier may be an object name of the target virtual object, an object serial number of the target virtual object, or another identifier that can uniquely represent the target virtual object. This is not limited in this embodiment of this disclosure. The information acquisition request is used for obtaining object information of the target virtual object. For example, the viewer user selects the selectable virtual object 1, and the electronic device determines the selectable virtual object 1 as the target virtual object in response to the selection instruction of the viewer user, and transmits an information acquisition request to the server, the information acquisition request carrying an object name of the selectable virtual object 1.

Step 203: The server receives the information acquisition request transmitted by the electronic device, and obtains the object information of the target virtual object based on the information acquisition request.

In a possible implementation, the server stores object information of the selectable virtual objects and a correspondence between the object information of the selectable virtual objects and object identifiers of the selectable virtual objects. After receiving the information acquisition request transmitted by the electronic device, the server parses the information acquisition request to obtain the object identifier of the target virtual object carried in the information acquisition request. The server obtains the object information of the target virtual object based on the object identifier of the target virtual object and the correspondence between the object information of the selectable virtual objects and the object identifiers of the selectable virtual objects. The object information includes, but not limited to, at least one of an object name, an object avatar, an object popularity value, an object attribute, an object skill, an object task, a use duration, and an object story. For example, the object name is the name of the object in the game, the object avatar is the display style of the object in the game, the object popularity value is used for indicating the popularity of the object, the object attribute is the species information of the object, and the object skill is the capability of the object for mastering and using a specialized technology, the object task is a task that needs to be completed in the object control process, the use duration is the one-time control duration of the object, or the use duration is a duration for which the target virtual object is allowed to be controlled, and the object story is a story about the object in the game. For example, the target virtual object is the selectable virtual object 1, and the information acquisition request carries the object identifier of the selectable virtual object 1. Based on the object identifier of the selectable virtual object 1 and the correspondence between the object information of the selectable virtual objects and the object identifiers of the selectable virtual objects, object information of the selectable virtual object 1 is obtained. That is, the object information of the target virtual object is obtained. The object information of the selectable virtual object is set by the game developer, and may also be modified by a viewer user who has controlled the selectable virtual object. The object information of the selectable virtual objects and the object identifiers of the selectable virtual objects may be stored in a KEY-VALUE form. For example, the object information of the selectable virtual objects is KEY, and the object identifiers of the selectable virtual objects are VALUE. Alternatively, the object identifiers of the selectable virtual objects are KEY, and the object information of the selectable virtual objects is VALUE. Certainly, other storage manners may alternatively be used to store the object information of the selectable virtual objects and the object identifiers of the selectable virtual objects, which is not limited in this embodiment of this disclosure.

Step 204: The server transmits the object information of the target virtual object to the electronic device.

In a possible implementation, after obtaining the object information of the target virtual object, the server may immediately transmit the object information of the target virtual object to the electronic device, and the electronic device calls the first client to display the object information of the target virtual object. Certainly, the server may alternatively stay for a first duration after obtaining the object information of the target virtual object, and then transmit the object information of the target virtual object to the electronic device. The timing for transmitting the object information of the target virtual object is not limited in this embodiment of this disclosure. The first duration may be any value, which is not limited in this embodiment of this disclosure. For example, the first duration is 10 seconds. In another example, the first duration is 30 seconds.

Step 205: The electronic device receives the object information of the target virtual object transmitted by the server, and displays the object information of the target virtual object.

In a possible implementation, after receiving the object information of the target virtual object transmitted by the server, the electronic device calls the first client to display the object information of the target virtual object. The display manner may be displaying the object information of the target virtual object on the first live streaming resource in a superimposition manner. The display manner may alternatively be canceling the display of the first live streaming resource and displaying the object information of the target virtual object. The display manner of the object information of the target virtual object is not limited in this embodiment of this disclosure.

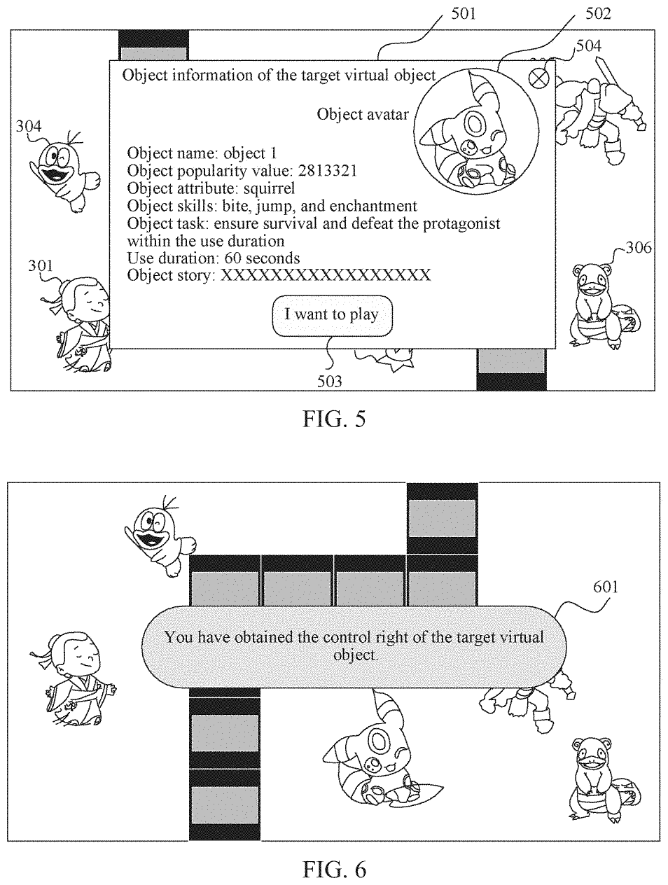

FIG. 5 is a schematic diagram of display of object information of a target virtual object according to an embodiment of this disclosure. In FIG. 5, the target virtual object is the selectable virtual object 1, and the display manner in FIG. 5 is displaying the object information of the target virtual object on the first live streaming resource in a superimposition manner. The object information of the selectable virtual object 1 is displayed in an object information display control 501 in FIG. 5, and an object avatar of the selectable virtual object 1 is displayed in an object avatar display control 502. The object name of the selectable virtual object 1 is object 1, the object popularity value thereof is 2813321, the object attribute thereof is squirrel, the object skills are bite, jump, and enchantment, the object task is to ensure survival and defeat the protagonist within the use duration, the use duration is 60 seconds.

Step 206: The electronic device transmits a control request to a server when a confirmation instruction for the object information of the target virtual object is received.

In a possible implementation, the object information display control 501 further includes a controlling control 503. As shown in FIG. 5, the controlling control 503 is a “I want to play” control. The electronic device displays the object information of the target virtual object for the viewer user to view the object information of the target virtual object. When the viewer user still decides to control the target virtual object after viewing the object information of the target virtual object, the viewer user may select the controlling control 503. After the viewer user selects the controlling control 503, the electronic device transmits a control request to the server, the control request carrying the object identifier of the target virtual object, and the control request being used for requesting to control the target virtual object. In a possible implementation, the object information display control 501 further includes a close control 504. When the viewer user no longer intends to control the target virtual object after viewing the object information of the target virtual object, the viewer user may select the close control 504 to cancel the display of the object information of the target virtual object. After the viewer user selects the close control 504, the electronic device cancels the display of the object information of the target virtual object, and redisplays the selectable virtual object box, that is, redisplays all the selectable virtual objects for the viewer user to re-determine the target virtual object.

When the viewer user re-determines the target virtual object, the acquisition process of the object information of the re-determined target virtual object is consistent with the acquisition process of the object information of the target virtual object, and details are not described herein again.

Step 207: The server receives the control request transmitted by the electronic device, and obtains an audio and video data stream address of the target virtual object.

In a possible implementation, the control request carries the object identifier of the target virtual object. After receiving the control request, the server parses the control request to obtain the object identifier of the target virtual object carried in the control request. An object state of the target virtual object is determined based on the object identifier of the target virtual object. The object state includes an uncontrolled state and a controlled state. The uncontrolled state is used for indicating that the target virtual object is not controlled by another viewer user, that is, the viewer user logged in to the electronic device can control the target virtual object. The controlled state is used for indicating that the target virtual object has been controlled by another viewer user, that is, the viewer user logged in to the electronic device cannot control the target virtual object.

In a possible implementation, the audio and video data stream address of the target virtual object is obtained when the object state of the target virtual object is the uncontrolled state. There are two implementations below for obtaining the audio and video data stream address of the target virtual object.

Implementation 1: Obtain an audio data stream and a video data stream of the target virtual object based on the object identifier of the target virtual object, and then obtain the audio and video data stream address of the target virtual object.

In a possible implementation, the server stores audio data streams and video data streams of all the selectable virtual objects, a correspondence between the object identifiers and the audio data streams, and a correspondence between the object identifiers and the video data streams. When the object state of the target virtual object is the uncontrolled state, the audio data stream of the target virtual object is obtained based on the object identifier of the target virtual object and the correspondence between the object identifiers and the audio data streams. The video data stream of the target virtual object is obtained based on the object identifier of the target virtual object and the correspondence between the object identifiers and the video data streams. The audio data stream of the target virtual object and the video data stream of the target virtual object are processed to obtain an audio and video data stream of the target virtual object, and then the audio and video data stream address of the target virtual object is determined. The process of processing the audio data stream of the target virtual object and the video data stream of the target virtual object is: encoding, mixing, and transcoding the audio data stream of the target virtual object and the video data stream of the target virtual object to obtain an audio and video data stream of the target virtual object.

Implementation 2: Obtain the audio and video data stream address of the target virtual object based on the object identifier of the target virtual object.

In a possible implementation, the server stores audio and video data stream addresses of all the selectable virtual objects and a correspondence between the object identifiers and the audio and video data stream addresses of the selectable virtual objects. When the object state of the target virtual object is the uncontrolled state, the audio and video data stream address of the target virtual object is obtained based on the object identifier of the target virtual object and the correspondence between the object identifiers and the audio and video data stream addresses of the selectable virtual objects. The audio and video data stream address is an address of the audio and video data stream. The format of the audio and video data stream address may be a real time messaging protocol (RTMP) format, a real time streaming protocol (RTSP) format, an HTTP live streaming (HLP) format, or other formats. This is not limited in this embodiment of this disclosure. Any one of the foregoing implementations may be selected to obtain the audio and video data stream address of the target virtual object. This is not limited in this embodiment of this disclosure.

In a possible implementation, the server receives the control request transmitted by the electronic device, and parses the control request to obtain the object identifier of the target virtual object carried in the control request. An object state of the target virtual object is determined based on the object identifier of the target virtual object. When the object state of the target virtual object is the uncontrolled state, the control right of the target virtual object is given to the viewer user, and third prompt information is transmitted to the electronic device to prompt the viewer user in the electronic device to control the target virtual object. The third prompt information and the first live streaming resource are displayed on the display interface of the electronic device, so that the viewer user logged in to the electronic device can control the target virtual object based on the first live streaming resource.

Step 208: The server transmits the audio and video data stream address of the target virtual object to the electronic device.

In a possible implementation, after obtaining the audio and video data stream address of the target virtual object, the server may immediately transmit the audio and video data stream address of the target virtual object to the electronic device, or may transmit the audio and video data stream address of the target virtual object to the electronic device after a second duration. The timing for transmitting the audio and video data stream address of the target virtual object is not limited in this embodiment of this disclosure.

The second duration may be any duration, which is not limited in this embodiment of this disclosure. For example, the second duration is 10 seconds. A shorter second duration represents a shorter delay in displaying the second live streaming resource in the electronic device. The second duration may be consistent with the first duration, or may be inconsistent with the first duration, which is also not limited in this embodiment of this disclosure.

In a possible implementation, after the server transmits the audio and video data stream address of the target virtual object to the electronic device, the server may further transmit third prompt information to the electronic device. The third prompt information is used for indicating that the viewer user logged in to the electronic device can control the target virtual object. For example, the content of the third prompt information is “You have obtained the control right of the target virtual object.” The third prompt information may further include the use duration of the target virtual object. For example, the content of the third prompt information is “You have obtained the control right of the target virtual object, and the time limit is 60 seconds.” Certainly, the content of the third prompt information may alternatively be other content. The content of the third prompt information is not limited in this embodiment of this disclosure.

In a possible implementation, before transmitting the audio and video data stream address of the target virtual object to the electronic device, the object state of the target virtual object is the uncontrolled state. After the server transmits the audio and video data stream address of the target virtual object to the electronic device, the server further needs to adjust the object state of the target virtual object, and adjusts the object state of the target virtual object to the controlled state, to prevent the situation that two or more viewer users control one target virtual object. In a possible implementation, when the object state of the target virtual object is the controlled state, because the controlled state is used for indicating that the target virtual object has been controlled by another viewer user, that is, the viewer user logged in to the electronic device cannot control the target virtual object. Therefore, the server transmits first prompt information to the electronic device, the first prompt information being used for indicating that the target virtual object is a virtual object that has been controlled by another viewer user. The content of the first prompt information may be “The target virtual object is being played by another viewer, please try again later.” Certainly, the first prompt information may alternatively be other content, which is not limited in this embodiment of this disclosure.

Step 209: The electronic device receives the audio and video data stream address of the target virtual object transmitted by the server, and displays a second live streaming resource based on the audio and video data stream address of the target virtual object.

In a possible implementation, the electronic device receives the audio and video data stream address of the target virtual object transmitted by the server, and obtains the audio and video data stream of the target virtual object based on the audio and video data stream address of the target virtual object. The first client is called to play the second live streaming resource corresponding to the audio and video data stream of the target virtual object, and the second live streaming resource is the audio and video corresponding to the target virtual object. For example, the second live streaming resource is an audio and video obtained from the viewpoint of the target virtual object.

In a possible implementation, the second live streaming resource may be displayed on the first live streaming resource in a superimposition manner, or the first live streaming resource may be replaced with the second live streaming resource (only the second live streaming resource is displayed, and the first live streaming resource is not displayed), or the first live streaming resource and second live streaming resources may be displayed simultaneously. In a possible implementation, for the manner of displaying the first live streaming resource and the second live streaming resource simultaneously, the display interface of the electronic device is divided into two display regions, where the first live streaming resource is displayed in one display region, and the second live streaming resource is displayed in the other display region. Sizes of the display regions of the first live streaming resource and the second live streaming resource may be same or different. This is not limited in this embodiment of this disclosure.

In a possible implementation, the electronic device may alternatively display the second live streaming resource in a target rendering form, and the acquisition process of the target rendering form is shown in step 201. Details are not described herein again.

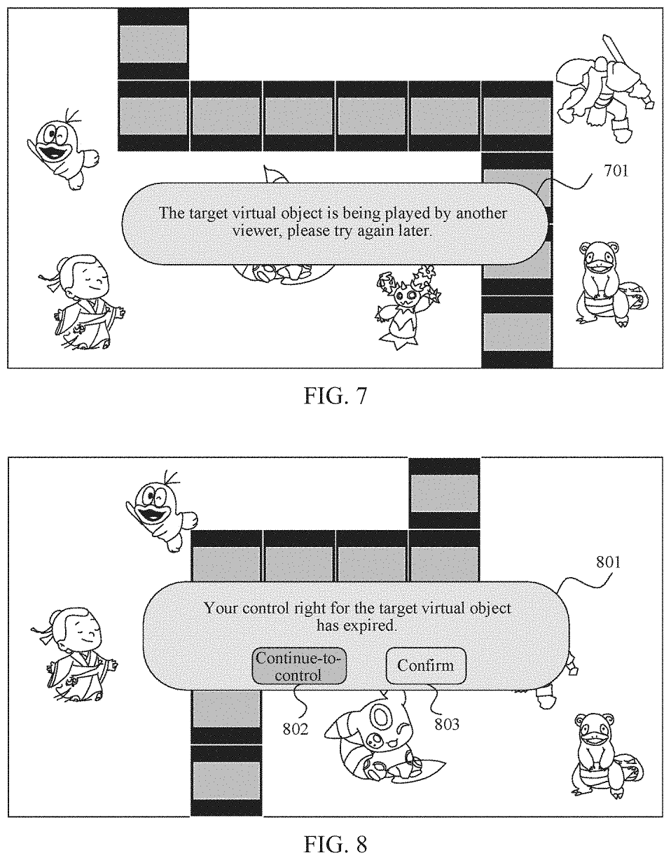

In a possible implementation, after the electronic device receives the audio and video data stream address of the target virtual object, the electronic device receives the third prompt information transmitted by the server. After calling the first client to display the second live streaming resource, the electronic device displays the third prompt information on the second live streaming resource in a superimposition manner. FIG. 6 is a schematic diagram of display of third prompt information according to an embodiment of this disclosure. In FIG. 6, the first live streaming resource is replaced with the second live streaming resource, that is, only the second live streaming resource is displayed, and the first live streaming resource is not displayed. A control 601 in FIG. 6 is a third prompt information display box, and the third prompt information displayed in FIG. 6 is “You have obtained the control right of the target virtual object.” The content displayed below the third prompt information is the second live streaming resource. In a possible implementation, when the object state of the target virtual object is the controlled state, the server transmits the first prompt information to the electronic device. After the electronic device receives the first prompt information, the electronic device calls the first client to display the first prompt information. The first prompt information is displayed on the first live streaming resource in a superimposition manner, so that the viewer user can be notified that he cannot control the target virtual object while the viewer user's viewing of the first live streaming resource is not affected. FIG. 7 is a schematic diagram of display of first prompt information according to an embodiment of this disclosure. A control 701 in FIG. 7 is a first prompt information display box, and the first prompt information displayed in FIG. 7 is “The target virtual object is being played by another viewer, please try again later.”

Step 210: The electronic device receives a control instruction for the target virtual object.

In a possible implementation, the electronic device displays the second live streaming resource, and the viewer user logged in to the electronic device may control the target virtual object in the second live streaming resource based on the second live streaming resource. The viewer user may drag the target virtual object to control the target virtual object, and may also control the target virtual object by dragging a skill button, and may alternatively control the target virtual object in other manners. This is not limited in this embodiment of this disclosure. In some implementations, the skill key is a physical key, for example, a physical joystick or button. In some other implementations, the skill button is a virtual button, for example, a control displayed on the second live streaming resource. For example, a first skill button and a second skill button are displayed in the second live streaming resource. The first skill button is a moving skill button. When the viewer user drags the first skill button, the control instruction for the target virtual object obtained by the electronic device is a movement instruction. The second skill button is a casting skill button. When the viewer user drags the second skill button, the control instruction for the target virtual object obtained by the electronic device is a casting instruction.

Step 211: The electronic device transmits the control instruction to the server.

In a possible implementation, after obtaining the control instruction, the electronic device may immediately transmit the control instruction to the server, or may transmit the control instruction to the server after staying for a third duration. The timing for transmitting the control instruction is not limited in this embodiment of this disclosure. The third duration may be any value, which is also not limited in this embodiment of this disclosure. The third duration may be consistent with the first duration or the second duration, or may be inconsistent with the first duration or the second duration.

Step 212: The server receives the control instruction transmitted by the electronic device, and transmits the control instruction to the game client.

In a possible implementation, a cloud game interactive SDK is accessed to the game client, and the server transmits the control instruction to the game client. The control instruction is used for instructing the game client to control the target virtual object to perform the target operation. The process in which the game client controls the target virtual object to perform the target operation can be displayed in the second live streaming resource. The target operation is an operation corresponding to the control instruction. For example, the control instruction is to turning left, and the target operation is to control the target virtual object to turn left.

In a possible implementation, after receiving the control instruction, the game client controls, based on the control instruction, the target virtual object to perform the target operation corresponding to the control instruction. For example, the control instruction is moving two steps to the left, then the game client controls the target virtual object to move two steps to the left, and the target virtual object displayed in the second live streaming resource on the electronic device moves two steps to the left. In another example, the control instruction is to bite the protagonist, then the game client controls the target virtual object to bite the protagonist, and the process in which the target virtual object bites the protagonist is displayed in the second live streaming resource on the electronic device.

Step 213: Transmit second prompt information to the electronic device when a difference between a control duration of the target virtual object and a use duration of the target virtual object is less than or equal to a duration threshold.

The control duration is a duration for which the target virtual object has been controlled, and the use duration is a duration for which the target virtual object is allowed to be controlled. In a possible implementation, the object information of the target virtual object includes the use duration of the target virtual object, and when the difference between the control duration of the viewer user logged in to the electronic device for the target virtual object and the use duration of the target virtual object is less than or equal to the duration threshold, the server transmits second prompt information to the electronic device, the second prompt information being used for indicating that the difference between the control duration of the target virtual object and the use duration of the target virtual object is less than or equal to the duration threshold, to prompt the viewer user logged in to the electronic device that he cannot continue to control the target virtual object. For example, the content of the second prompt information is “Your control right for the target virtual object has expired.” Certainly, the content of the second prompt information may alternatively be other content, which is not limited in this embodiment of this disclosure. The value of the duration threshold is not limited in this embodiment of this disclosure, and the value of the duration threshold may be set according to experience or actual requirements. For example, the value of the duration threshold may be set to zero, then when the difference between the control duration of the target virtual object and the use duration of the target virtual object is equal to zero, that is, the control duration of the target virtual object and the use duration of the target virtual object are consistent, the server transmits the second prompt information to the electronic device.

In a possible implementation, after transmitting the second prompt information to the electronic device, the server further needs to adjust the object state of the target virtual object, and adjusts the object state of the target virtual object to the uncontrolled state, so that another viewer user can control the target virtual object.

Step 214: The electronic device receives the second prompt information transmitted by the server, and displays the second prompt information.

In a possible implementation, after receiving the second prompt information transmitted by the server, the electronic device displays the second prompt information on the second live streaming resource in a superimposition manner. FIG. 8 is a schematic diagram of display of second prompt information according to an embodiment of this disclosure. A control 801 in FIG. 8 is a second prompt information display box, and the second prompt information displayed in FIG. 8 is “Your control right for the target virtual object has expired.”

In a possible implementation, a continue-to-control control 802 and a confirm control 803 may further be displayed in the second prompt information display box. The continue-to-control control 802 is configured to request to continue to control the target virtual object, and the confirm control 803 is configured to confirm no longer continuing to control the target virtual object. When the viewer user intends to continue to control the target virtual object, the viewer user selects the continue-to-control control 802, and then transmits a continue-to-control request to the server, the continue-to-control request carrying the object identifier of the target virtual object. After receiving the continue-to-control request, the server parses the continue-to-control request to obtain the object identifier of the target virtual object carried in the continue-to-control request. An object state of the target virtual object is determined based on the object identifier of the target virtual object. If the object state of the target virtual object is the uncontrolled state, the audio and video data stream address of the target virtual object is obtained, and the audio and video data stream address of the target virtual object is returned to the electronic device, so that the viewer user logged in to the electronic device can continue to control the target virtual object. If the object state of the target virtual object is the controlled state, first prompt information is returned to the electronic device to prompt the viewer user logged in to the electronic device that he temporarily cannot control the target virtual object.

Step 215: The server obtains a reward resource corresponding to the target virtual object when the object task of the target virtual object is completed within the use duration of the target virtual object.

In a possible implementation, because the object information of the target virtual object includes the use duration of the target virtual object and the object task of the target virtual object, to enable the viewer user to continue to control the target virtual object, improve the attractiveness of the game to the viewer user, and further increase the interaction between the viewer user and the anchor user, when the viewer user logged in to the electronic device completes the object task of the target virtual object within the use duration of the target virtual object, the server may reward the viewer user logged in to the electronic device. The server stores reward resources of all the selectable virtual objects and a correspondence between the object identifiers and the reward resources. The server obtains the object identifier of the target virtual object when the object task of the target virtual object is completed within the use duration of the target virtual object. The reward resource corresponding to the target virtual object is determined based on the object identifier of the target virtual object and the correspondence between the object identifiers and the reward resources. The reward resource may be an empirical value, a voucher, or gold coins, and the form of the reward resource is not limited in this embodiment of this disclosure.

Table 1 below is a table of a correspondence between the object identifiers and the reward resources provided in this embodiment of this disclosure.

TABLE 1

| Object identifiers | Reward resources |
|---|---|
| Selectable virtual object 1 | Add 200 to the empirical value |
| Selectable virtual object 2 | Add 100 gold coins |
| Selectable virtual object 3 | 50 yuan voucher |

In Table 1, when the object identifier is selectable virtual object 1, the corresponding reward resource is adding 200 to the empirical value; when the object identifier is selectable virtual object 2, the corresponding reward resource is adding 100 gold coins; and when the object identifier is selectable virtual object 3, the corresponding reward resource is a 50 yuan voucher. Table 1 is only an example of the object identifiers and the reward resources provided in this embodiment of this disclosure, and is not intended to limit the object identifiers and reward resources. The reward resource corresponding to each selectable virtual object is set by the game developer, or modified by the viewer user who has controlled the selectable virtual object. The reward resource corresponding to each selectable virtual object is not limited in this embodiment of this disclosure. For example, the target virtual object is the selectable virtual object 1, and it is determined based on Table 1 that the reward resource corresponding to the target virtual object is adding 200 to the empirical value.

In a possible implementation, when the viewer user logged in to the electronic device fails to complete the object task of the target virtual object within the use duration of the target virtual object, the server may further obtain a punishment resource corresponding to the target virtual object. The server stores punishment resources of the selectable virtual objects and a correspondence between the object identifiers and the punishment resources. When the object task of the target virtual object is not completed within the use duration of the target virtual object, the punishment resource corresponding to the target virtual object is determined based on the object identifier of the target virtual object and the correspondence between the object identifiers and the punishment resources. The punishment resource may be an empirical value, gold coins, or a level decrease, and the form of the punishment resource is not limited in this embodiment of this disclosure.

Table 2 below is a table of a correspondence between the object identifiers and the punishment resources provided in this embodiment of this disclosure.

TABLE 2

| Object identifiers | Punishment resources |
|---|---|
| Selectable virtual object 1 | Subtract 200 from the |
| | empirical value |
| Selectable virtual object 2 | Subtract 100 gold coins |
| Selectable virtual object 3 | Being lowered by one level |

In Table 2, when the object identifier is selectable virtual object 1, the corresponding punishment resource is subtracting 200 from the empirical value: when the object identifier is selectable virtual object 2, the corresponding punishment resource is subtracting 100 gold coins; and when the object identifier is selectable virtual object 3, the corresponding punishment resource is being lowered by one level. Table 2 is only an example of the object identifiers and the punishment resources provided in this embodiment of this disclosure, and is not intended to limit the object identifiers and the punishment resources. The punishment resource corresponding to each selectable virtual object is set by the game developer, or modified by the viewer user who has controlled the selectable virtual object. The punishment resource corresponding to each selectable virtual object is not limited in this embodiment of this disclosure.

Step 216: The server transmits the reward resource corresponding to the target virtual object to the electronic device.

In a possible implementation, after obtaining the reward resource corresponding to the target virtual object, the server transmits the reward resource corresponding to the target virtual object to the electronic device, so that the electronic device updates the account of the viewer user logged in to the electronic device based on the reward resource corresponding to the target virtual object. In a possible implementation, after the server obtains the punishment resource corresponding to the target virtual object, the server transmits the punishment resource corresponding to the target virtual object to the electronic device, so that the electronic device update the account of the viewer user logged in to the electronic device based on the punishment resource corresponding to the target virtual object.

Step 217: The electronic device receives the reward resource corresponding to the target virtual object transmitted by the server, and updates an account of the viewer user based on the reward resource corresponding to the target virtual object.

In a possible implementation, the electronic device receives the reward resource corresponding to the target virtual object transmitted by the server, and adds the reward resource corresponding to the target virtual object to the account of the viewer user logged in to the electronic device.

For example, the empirical value of the viewer user is 3000, and the reward resource corresponding to the target virtual object is an empirical value of 200. After the electronic device updates the account of the viewer user, the obtained empirical value of the viewer user is 3200. In a possible implementation, the electronic device receives the punishment resource corresponding to the target virtual object transmitted by the server, and updates the account of the viewer user logged in to the electronic device based on the punishment resource corresponding to the target virtual object. The foregoing steps 202 to 205, steps 207 to 209, and steps 211 to 217 are optional steps in this embodiment of this disclosure.

In the foregoing method, the first live streaming resource displayed by the electronic device includes selectable virtual objects, which improves the diversity of content displayed by the electronic device, so that viewer users can not only view the first live streaming resource, but also control controllable virtual objects in the first live streaming resource, thereby improving the level of participation and the level of activity of the viewer users, and making the interactivity between the viewer users and the anchor user of the first live streaming resource relatively high, and the control manners for virtual objects relatively plentiful and flexible. Further, the attractiveness of the first live streaming resource to the viewer users can be improved, and the competitiveness of the game corresponding to the first live streaming resource can be improved. In addition, the local game can be turned into a multiplayer online game. That is, the electronic device displays the first live streaming resource including the selectable virtual objects, and realizes control on the target virtual object according to the received selection instruction and control instruction, to enable the viewer users to play the game with the anchor user, so that the local game of the anchor user becomes a multiplayer online game between the viewer users and the anchor user. Therefore, the implementation of playing a game based on electronic devices is enriched, the implementation cost of the implementation is lower than the implementation cost of a conventional multiplayer game, and the extensibility is relatively strong.

In addition, when the viewer user controls the target virtual object, a second live streaming resource is further displayed. Because the second live streaming resource is the audio and video corresponding to the target virtual object, it is beneficial for the viewer user to better control the target virtual object.

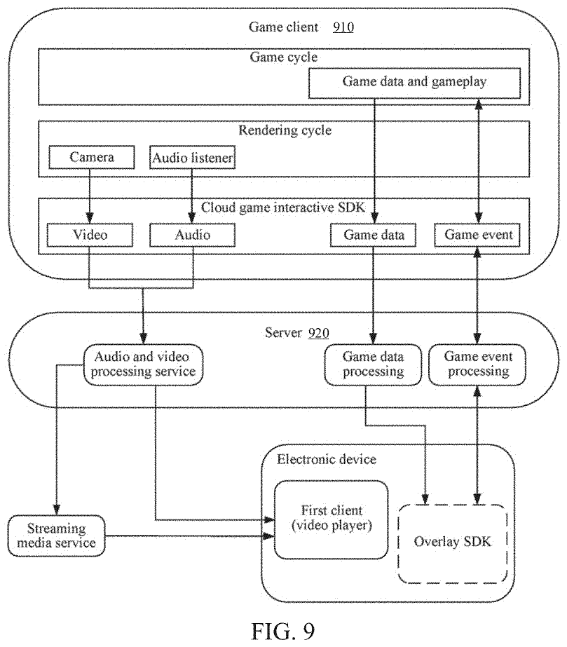

FIG. 9 is an architectural diagram of a virtual object control method according to an embodiment of this disclosure. The overall process is that: the game client 910 first integrates a cloud game interactive SDK, connects with the cloud game interactive SDK to realize logic including audio and video data acquisition, synchronization of game data (object information and object state), and game event processing (such as object control instructions). The anchor user plays the game through the game client 910. The cloud game interactive SDK responds audio data, video data, game data, and game events to a server 920. The server 920 processes an audio and a video through the audio and video processing service to obtain an audio and video data stream, and distributes the audio and video data stream to a streaming media service and an electronic device.

When the server 920 distributes the audio and video data stream to the streaming media service, the electronic device needs to obtain the audio and video data stream from the streaming media service, so that it takes a relatively long duration for the electronic device to obtain the audio and video data stream. When the server 920 directly distributes the audio and video data stream to the electronic device, it takes a relatively short duration for the electronic device to obtain the audio and video data stream. The electronic device plays the audio and video corresponding to the audio and video data stream by calling a first client (video player). The electronic device integrates an Overlay SDK of a cloud game, the Overlay SDK is configured to receive game data and display the game data on the video player in a superimposition manner, and is further configured to transmit a game event to the server 920 and receive a response to the game event from the server 920.

The cloud game interactive SDK part includes an audio and video module, a game data module, and a game event module. For example, the audio and video module includes a video module and an audio module shown in FIG. 9. The audio and video module is configured to capture the textures and audios in the game to form an audio and video data stream. The cloud game interactive SDK may be accessed to any quantity of cameras and audio listeners in the game, capture the corresponding textures and audios respectively, and form an audio and video data stream. The cloud game interactive SDK obtains data from the accessed cameras and audio listeners at a certain frequency. For example, the frequency may be determined according to the rendering cycle, such as capturing textures and audios at the end of each frame of rendering, or the frequency may be customized.

Herein, the term module (and other similar terms such as unit, submodule, etc.) may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module. A module is configured to perform functions and achieve goals such as those described in this disclosure, and may work together with other related modules, programs, and components to achieve those functions and goals.

The game data module is configured to: obtain game data, the game data including, but not limited to, object information of an selectable virtual object; and transmit the game data to the electronic device. A game data stream is similar to an audio and video data stream, and is a one-way push stream. The refresh frequency of the game data may be determined according to the game cycle. For example, the game data is refreshed once per game cycle period. The game cycle period may be determined according to the gameplay, which is not limited herein.

The game event module is configured to receive control events of the server and the electronic device, and various interaction behaviors of the viewer users and the game may be defined as game events. The game event module supports two-way communication between the game client and the outside world.

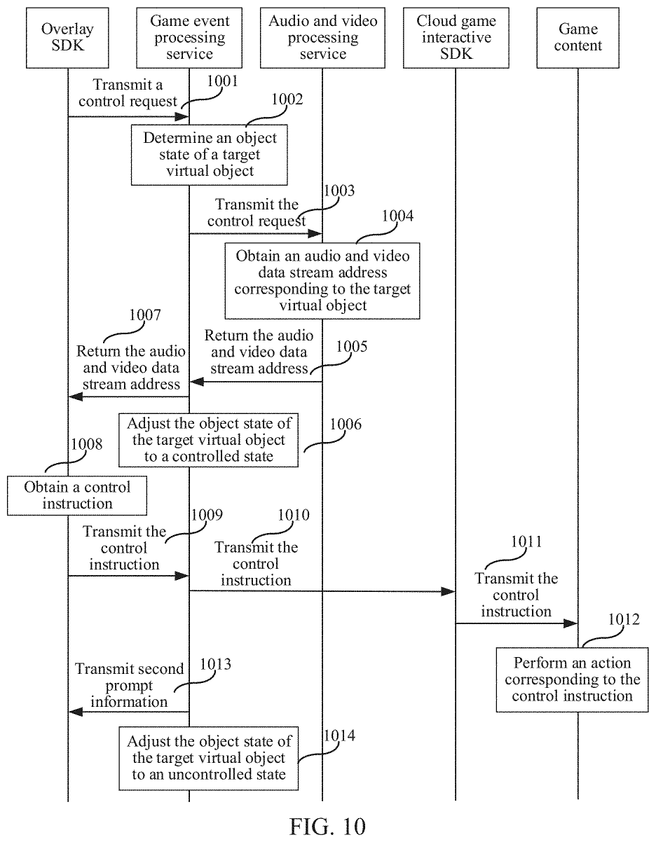

FIG. 10 is a flowchart of a virtual object control method according to an embodiment of this disclosure. In FIG. 10, an Overlay SDK is accessed to the electronic device, the server includes a game event processing service and an audio and video processing service, a cloud game interactive SDK is accessed to the game client, and the game client includes game content.

The Overlay SDK transmits a control request to the game event processing service (1001), the control request carrying an object identifier of a target virtual object, and the control request being used for requesting to control the target virtual object. The game event processing service receives the control request, parses the control request to obtain the object identifier of the target virtual object, and determines an object state of the target virtual object based on the object identifier of the target virtual object (1002). When the object state of the target virtual object is an uncontrolled state, the game event processing service transmits a control request to the audio and video processing service (1003). The audio and video processing service receives the control request, and obtains an audio and video data stream address corresponding to the target virtual object based on the object identifier of the target virtual object carried in the control request (1004). The audio and video processing service returns the audio and video data stream address of the target virtual object to the game event processing service (1005), and the game event processing service returns the audio and video data stream address of the target virtual object to the Overlay SDK (1006). In addition, the game event processing service further adjusts the object state of the target virtual object to a controlled state (1006). The Overlay SDK obtains a control instruction (1008), and transmits the control instruction to the game event processing service (1009). The game event processing service transmits the control instruction to the cloud game interactive SDK (1010), and then the cloud game interactive SDK transmits the control instruction to the game content (1011), and the game content performs an action corresponding to the control instruction (1012). When a difference between a control duration of the target virtual object and a use duration of the target virtual object is less than or equal to a duration threshold, the game event processing service transmits second prompt information to the Overlay SDK to indicate that the target virtual object cannot continue to be controlled (1013). The game event processing service adjusts the object state of the target virtual object to the uncontrolled state, so that another viewer user can control the target virtual object (1014).

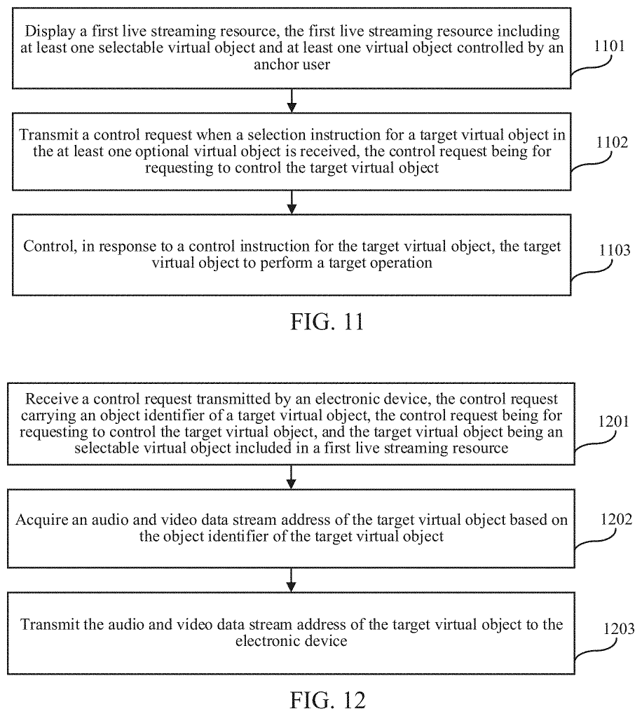

FIG. 11 is a flowchart of a virtual object control method according to an embodiment of this disclosure. The method may be performed by the electronic device 101 in FIG. 1, and as shown in FIG. 11, the method includes the following steps:

Step 1101: Display a first live streaming resource, the first live streaming resource including at least one selectable virtual object and at least one virtual object controlled by an anchor user.

In a possible implementation, the process of displaying the first live streaming resource is consistent with the process of step 201.

Step 1102: Transmit a control request when a selection instruction for a target virtual object in the at least one selectable virtual object is received, the control request being used for requesting to control the target virtual object.

In a possible implementation, the process of transmitting the control request is consistent with the process of steps 202 to 206.

Step 1103: Control, in response to a control instruction for the target virtual object, the target virtual object to perform a target operation.

In a possible implementation, the process of controlling the target virtual object to perform the target operation is consistent with the process of step 210 to step 212.

In the foregoing method, selectable virtual objects are displayed in the first live streaming resource, which improves the diversity of content displayed by the electronic device, so that viewer users can not only view the first live streaming resource, but also control controllable virtual objects in the first live streaming resource, thereby improving the level of participation and the level of activity of the viewer users, and making the interactivity between the viewer users and the anchor user of the first live streaming resource relatively high, and the control manners for virtual objects relatively plentiful and flexible. Further, the attractiveness of the first live streaming resource to the viewer users can be improved, and the competitiveness of the game corresponding to the first live streaming resource can be improved. In addition, the local game can be turned into a multiplayer online game, so that the implementation of playing a game based on electronic devices is enriched, the realization cost is lower than that of a conventional multiplayer game, the extensibility is relatively strong.

FIG. 12 is a flowchart of a virtual object control method according to an embodiment of this disclosure. The method may be performed by the server 102 in FIG. 1. As shown in FIG. 12, the method includes the following steps:

Step 1201: Receive a control request transmitted by an electronic device, the control request carrying an object identifier of a target virtual object, the control request being used for requesting to control the target virtual object, and the target virtual object being an selectable virtual object included in a first live streaming resource.

In a possible implementation, the process of receiving the control request transmitted by the electronic device is consistent with the process of step 207.

Step 1202: Obtain an audio and video data stream address of the target virtual object based on the object identifier of the target virtual object.

In a possible implementation, the process of obtaining the audio and video data stream address of the target virtual object is consistent with the process of step 207.

Step 1203: Transmit the audio and video data stream address of the target virtual object to the electronic device.

In a possible implementation, the process of transmitting the audio and video data stream address of the target virtual object to the electronic device is consistent with the process of step 208.

In the foregoing method, the audio and video data stream address of the target virtual object is obtained based on the control request, and then the audio and video data stream address is transmitted to the electronic device, so that the viewer user logged in to electronic device controls the target virtual object based on the audio and video data stream address. The control manners for virtual objects are relatively plentiful and flexible, and the diversity of content displayed by the electronic device is improved, so that the viewer user can not only view the first live streaming resource, but also control the target virtual object in the first live streaming resource, thereby improving the level of participation and the level of activity of the viewer users, and making the interactivity between the viewer users and the anchor user of the first live streaming resource relatively high. Further, the attractiveness of the first live streaming resource to the viewer users can be improved, and the competitiveness of the game corresponding to the first live streaming resource can be improved.

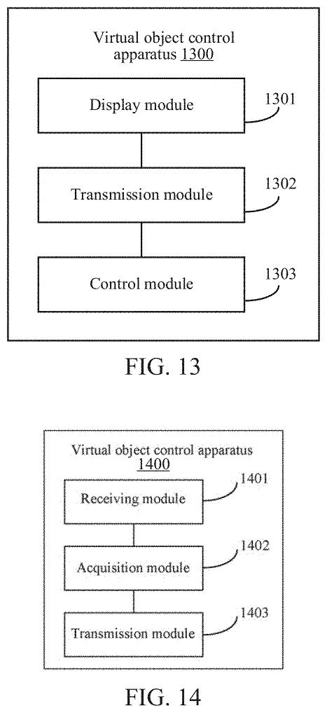

FIG. 13 is a schematic structural diagram of a virtual object control apparatus according to an embodiment of this disclosure. As shown in FIG. 13, the apparatus 1300 includes:

a display module 1301, configured to display a first live streaming resource, the first live streaming resource including at least one selectable virtual object and at least one virtual object controlled by an anchor user;

a transmission module 1302, configured to transmit a control request when a selection instruction for a target virtual object in the at least one selectable virtual object is received, the control request being used for requesting to control the target virtual object: and

a control module 1303, configured to control, in response to a control instruction for the target virtual object, the target virtual object to perform a target operation.

In a possible implementation, the apparatus further includes: an acquisition module, configured to obtain object information of the target virtual object when the selection instruction for the target virtual object in the at least one selectable virtual object is received;

the display module 1301 is further configured to display the object information of the target virtual object: and

the transmission module 1302 is configured to transmit the control request to a server when a confirmation instruction for the object information of the target virtual object is received, the control request carrying an object identifier of the target virtual object.

In a possible implementation, the transmission module 1302 is configured to transmit an information acquisition request to the server when the selection instruction for the target virtual object in the at least one selectable virtual object is received, the information acquisition request carrying the object identifier of the target virtual object, and the information acquisition request being used for obtaining the object information of the target virtual object: and

the apparatus further includes: a receiving module, configured to receive the object information of the target virtual object returned by the server based on the information acquisition request.

In a possible implementation, the transmission module 1302 is configured to: transmit the control instruction to a server in response to the control instruction for the target virtual object, and forward the control instruction to a game client through the server, the control instruction being used for instructing the game client to control the target virtual object to perform the target operation.

In a possible implementation, the display module 1301 is configured to: transmit a live streaming resource acquisition request to a server, the live streaming resource acquisition request carrying a live streaming studio identifier of a target live streaming studio: and receive the first live streaming resource returned by the server, and display the first live streaming resource, the first live streaming resource being obtained from a game client by the server based on the live streaming studio identifier of the target live streaming studio, and the first live streaming resource being obtained by playing a game through the game client by the anchor user of the target live streaming studio.

In a possible implementation, the receiving module is further configured to receive an audio and video data stream address of the target virtual object returned by a server: and

the display module 1301 is further configured to display a second live streaming resource based on the audio and video data stream address of the target virtual object, the second live streaming resource being an audio and video corresponding to the target virtual object.

In a possible implementation, the selectable virtual object is a virtual object controlled by AI.

In a possible implementation, the receiving module is further configured to receive first prompt information returned by the server, the first prompt information being used for indicating that the target virtual object is a virtual object that has been controlled by another viewer user; and

the display module 1301 is further configured to display the first prompt information.

In a possible implementation, the acquisition module is further configured to: obtain preference information of a viewer user based on user information of the viewer user, the viewer user including at least one of a user controlling the target virtual object and a user viewing the first live streaming resource, and obtain a target rendering form based on the preference information of the viewer user: and

the display module 1301 is configured to display the first live streaming resource in the target rendering form.

In a possible implementation, the receiving module is further configured to receive second prompt information transmitted by the server, the second prompt information being used for indicating that a difference between a control duration of the target virtual object and a use duration of the target virtual object is less than or equal to a duration threshold, the control duration being a duration for which the target virtual object has been controlled, and the use duration being a duration for which the target virtual object is allowed to be controlled; and the display module 1301 is further configured to display the second prompt information.

In a possible implementation, the selectable virtual object cannot be controlled by the anchor user.

The foregoing apparatus displays selectable virtual objects in the first live streaming resource, so that viewer users can not only view the first live streaming resource, but also control controllable virtual objects in the first live streaming resource, thereby improving the level of participation and the level of activity of the viewer users, and making the interactivity between the viewer users and the anchor user of the first live streaming resource relatively high. Further, the attractiveness of the first live streaming resource to the viewer users can be improved, and the competitiveness of the game corresponding to the first live streaming resource can be improved. In addition, the local game can be turned into a multiplayer online game, the realization cost is lower than that of a conventional multiplayer game, the extensibility is relatively strong. In addition, the control manners for virtual objects are relatively plentiful and flexible, thereby enriching the implementations for performing a game based on electronic devices.

FIG. 14 is a schematic structural diagram of a virtual object control apparatus according to an embodiment of this disclosure. As shown in FIG. 14, the apparatus 1400 includes:

a receiving module 1401, configured to receive a control request transmitted by an electronic device, the control request carrying an object identifier of a target virtual object, the control request being used for requesting to control the target virtual object, and the target virtual object being an selectable virtual object included in a first live streaming resource:

an acquisition module 1402, configured to obtain an audio and video data stream address of the target virtual object based on the object identifier of the target virtual object; and

a transmission module 1403, configured to transmit the audio and video data stream address of the target virtual object to the electronic device.

In a possible implementation, the apparatus further includes: a determining module, configured to determine an object state of the target virtual object based on the object identifier of the target virtual object: and

the acquisition module 1402 is configured to obtain the audio and video data stream address of the target virtual object when the object state of the target virtual object is an uncontrolled state.

In a possible implementation, the receiving module 1401 is further configured to receive a control instruction transmitted by the electronic device; and

the transmission module 1403 is further configured to transmit the control instruction to a game client, the control instruction being used for instructing the game client to control the target virtual object to perform a target operation.

In a possible implementation, the receiving module 1401 is further configured to: receive a live streaming resource acquisition request transmitted by the electronic device, the live streaming resource acquisition request carrying a live streaming studio identifier of a target live streaming studio: parse the live streaming resource acquisition request to obtain the live streaming studio identifier of the target live streaming studio: and obtaining the first live streaming resource from a game client based on the live streaming studio identifier of the target live streaming studio, and returning the first live streaming resource to the electronic device, the first live streaming resource being obtained by playing a game through the game client by an anchor user of the target live streaming studio. In some cases, the game client is a game client in the anchor user's electronic device.

In a possible implementation, the transmission module 1403 is further configured to transmit first prompt information to the electronic device when the object state of the target virtual object is a controlled state, the first prompt information being used for indicating that the target virtual object is a virtual object that has been controlled by another viewer user.

In a possible implementation, the receiving module 1401 is further configured to receive an information acquisition request transmitted by the electronic device, the information acquisition request carrying the object identifier of the target virtual object, and the information acquisition request being used for obtaining object information of the target virtual object;

the acquisition module 1402 is further configured to obtain the object information of the target virtual object based on the object identifier of the target virtual object; and

the transmission module 1403 is further configured to transmit the object information of the target virtual object to the electronic device, and displaying the object information of the target virtual object through the electronic device.

In a possible implementation, the apparatus further includes: an adjustment module, configured to adjust the object state of the target virtual object to a controlled state.

In a possible implementation, the object information of the target virtual object includes a use duration and an object task, the use duration being a duration for which the target virtual object is allowed to be controlled, and the acquisition module 1402 is further configured to obtain a reward resource corresponding to the target virtual object w % ben the object task of the target virtual object is completed within the use duration of the target virtual object; and

the transmission module 1403 is further configured to transmit the reward resource corresponding to the target virtual object to the electronic device.

In a possible implementation, the transmission module 1403 is further configured to transmit second prompt information to the electronic device when a difference between a control duration of the target virtual object and a use duration of the target virtual object is less than or equal to a duration threshold, the second prompt information being used for indicating that the difference between the control duration of the target virtual object and the use duration of the target virtual object is less than or equal to the duration threshold, the control duration being a duration for which the target virtual object has been controlled, and the use duration being a duration for which the target virtual object is allowed to be controlled; and the adjustment module is further configured to adjust the object state of the target virtual object to the uncontrolled state.

In a possible implementation, the selectable virtual object cannot be controlled by the anchor user.

The foregoing apparatus obtains the audio and video data stream address of the target virtual object based on the control request, and then transmits the audio and video data stream address to the electronic device, so that the viewer user logged in to electronic device controls the target virtual object based on the audio and video data stream address, so that the viewer user can not only view the first live streaming resource, but also control the target virtual object in the first live streaming resource, thereby improving the level of participation and the level of activity of the viewer users, and making the interactivity between the viewer users and the anchor user of the first live streaming resource relatively high. Further, the attractiveness of the first live streaming resource to the viewer users can be improved, and the competitiveness of the game corresponding to the first live streaming resource can be improved. Moreover, the control manners for virtual objects are relatively plentiful and flexible.

When the apparatus provided in FIG. 13 and FIG. 14 implements functions of the apparatus, the division of the foregoing functional modules is merely an example for description. In the practical application, the functions may be assigned to and completed by different functional modules according to the requirements, that is, the internal structure of the device is divided into different functional modules, to implement all or some of the functions described above. In addition, the apparatus and method embodiments provided in the foregoing embodiments belong to the same conception. For the specific implementation process, reference may be made to the method embodiments.

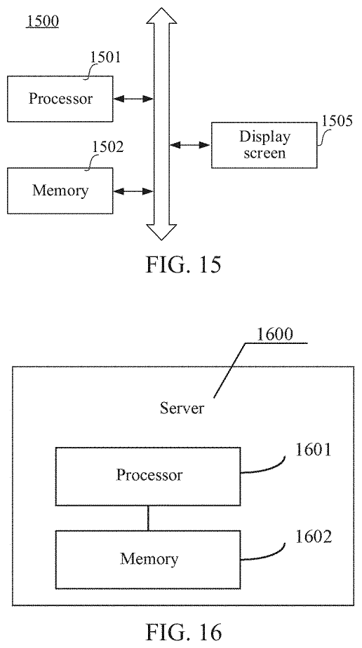

FIG. 15 is a structural block diagram of an electronic device 1500 according to an exemplary embodiment of this disclosure. The electronic device 1500 may be a portable mobile terminal, for example, a smartphone, a tablet computer, a Moving Picture Experts Group Audio Layer III (MP3) player, a Moving Picture Experts Group Audio Layer IV (MP4) player, a notebook computer, or a desktop computer. The electronic device 1500 may also be referred to as another name such as user equipment, a portable terminal, a laptop terminal, or a desktop terminal.

Generally, the electronic device 1500 includes a processor 1501 and a memory 1502. The processor 1501 may include one or more processing cores, and may be, for example, a 4-core processor or an 8-core processor The processor 1501 may be implemented by using at least one hardware form of a digital signal processor (DSP), a field-programmable gate array (FPGA), and a programmable logic array (PLA). The processor 1501 may alternatively include a main processor and a coprocessor. The main processor is a processor configured to process data in an awake state, also referred to as a central processing unit (CPU), and the coprocessor is a low-power processor configured to process data in a standby state. In some embodiments, the processor 1501 may be integrated with a graphics processing unit (GPU). The GPU is configured to render and draw content that needs to be displayed on a display screen. In some embodiments, the processor 1501 may further include an AI processor. The AI processor is configured to process a computing operation related to machine learning. The memory 1502 may include one or more computer-readable storage media. The computer-readable storage media may be non-transient. The memory 1502 may further include a high-speed random access memory (RAM), and a non-volatile memory such as one or more magnetic disk storage devices and a flash storage device. In some embodiments, the non-transient computer-readable storage medium in the memory 1502 is configured to store at least one instruction. The at least one instruction is executed by the processor 1501 to implement the virtual object control method provided in the method embodiments of this disclosure.

In some embodiments, the electronic device 1500 may include a display screen 1505, the display screen 1505 being configured to play a game live streaming resource of an anchor user, for example, configured to display the first live streaming resource and the second live streaming resource mentioned above.

The display screen 1505 is configured to display a user interface (UI). The UI may include a graphic, a text, an icon, a video, and any combination thereof. When the display screen 1505 is a touch display screen, the display screen 1505 further has a capability of obtaining a touch signal on or above a surface of the display screen 1505. The touch signal may be used as a control signal to be inputted into the processor 1501 for processing. In this case, the display screen 1505 may be further configured to provide at least one of a virtual button and a virtual keyboard, also referred to as at least one of a soft button and a soft keyboard. In some embodiments, there may be one display screen 1505, disposed on a front panel of the electronic device 1500. In some other embodiments, there may be at least two display screens 1505, respectively disposed on different surfaces of the electronic device 1500 or designed in a foldable shape. In some other embodiments, the display screen 1505 may be a flexible display screen, disposed on a curved surface or a folded surface of the electronic device 1500. Even, the display screen 1505 may be further set in a non-rectangular irregular pattern, namely, a special-shaped screen. The display screen 1505 may be prepared by using materials such as a liquid-crystal display (LCD), an organic light-emitting diode (OLED), or the like.

A person skilled in the art may understand that a structure shown in FIG. 15 constitutes no limitation on the electronic device 1500, and the electronic device may include more or fewer components than those shown in the figure, or some components may be combined, or a different component deployment may be used.

FIG. 16 is a schematic structural diagram of a server according to an embodiment of this disclosure. The server 1600 may vary greatly according to configuration or performance, and may include one or more central processing units (CPUs) 1601 and one or more memories 1602. The one or more memories 1602 store at least one piece of program code. The at least one piece of program code is loaded by the one or more processors 1601 to implement the virtual object control method provided in the foregoing method embodiments. Certainly, the server 1600 may further have a wired or wireless network interface, a keyboard, an input/output interface, and other components to facilitate input/output. The server 1600 may further include other components for implementing device functions.

In an exemplary embodiment, a virtual object control system is further provided. The virtual object control system includes an electronic device and a server. For example, the electronic device is configured to implement the embodiment shown in FIG. 11, and the server is configured to implement the embodiment shown in FIG. 12. For example, the electronic device interacts with the server, to implement the embodiment shown in FIG. 2.

In an exemplary embodiment, a computer-readable storage medium is further provided, the storage medium storing at least one piece of program code, the at least one piece of program code being loaded and executed by a processor, to cause a computer to implement any one of the virtual object control methods described above. In an exemplary implementation, the foregoing computer-readable storage medium may be a read-only memory (ROM), a random access memory (RAM), a compact disc ROM (CD-ROM), a magnetic tape, a floppy disk, an optical data storage device, or the like.

In an exemplary embodiment, a computer program or computer program product is further provided, the computer program or computer program product storing at least one computer instruction, the at least one computer instruction being loaded and executed by a processor to cause a computer to implement any one of the virtual object control methods described above.

The foregoing descriptions are merely exemplary embodiments of this disclosure, but are not intended to limit this disclosure. Any modification, equivalent replacement, or improvement made within the principle of this disclosure shall fall within the protection scope of this disclosure.

What is claimed is:

1. A virtual object control method, performed by an electronic device of a viewer user, comprising:
displaying a first live streaming resource, the first live streaming resource comprising at least one selectable virtual object and at least one virtual object controlled by an anchor user;
transmitting a control request in response to receiving a selection instruction for a target virtual object in the at least one selectable virtual object, the control request being for requesting to control the target virtual object; and
controlling, in response to a control instruction for the target virtual object, the target virtual object to perform a target operation.

2. The method according to claim 1, wherein the transmitting the control request in response to receiving the selection instruction for the target virtual object comprises:
displaying object information of the target virtual object in response to receiving the selection instruction for the target virtual object in the at least one selectable virtual object; and
transmitting the control request to a server in response to receiving a confirmation instruction for the object information of the target virtual object, the control request carrying an object identifier of the target virtual object.

3. The method according to claim 1, wherein the first live streaming resource is for a cloud gaming, and a server renders a game scene of the cloud gaming into a video and audio stream and transmit the video and audio stream to the electronic device.

4. The method according to claim 1, wherein the controlling the target virtual object to perform the target operation comprises:
transmitting the control instruction to a server in response to the control instruction for the target virtual object, wherein the control instruction being forwarded to a game client by the server and being for instructing the game client to control the target virtual object to perform the target operation.

5. The method according to claim 1, wherein the displaying the first live streaming resource comprises:
transmitting a live streaming resource acquisition request to a server, the live streaming resource acquisition request carrying a live streaming studio identifier of a target live streaming studio;
receiving the first live streaming resource returned by the server, the first live streaming resource representing a game being played by the anchor user of the target live streaming studio using a game client, and the server obtaining the first live streaming resource from the game client based on the live streaming studio identifier of the target live streaming studio; and
displaying the first live streaming resource.

6. The method according to claim 1, wherein the method further comprises:
receiving an audio and video data stream address of the target virtual object returned by a server; and
displaying a second live streaming resource based on the audio and video data stream address of the target virtual object, the second live streaming resource being an audio and video corresponding to the target virtual object.

7. The method according to claim 1, wherein the selectable virtual object is a virtual object controlled by artificial intelligence before being controlled by a viewer.

8. The method according to claim 1, wherein the method further comprises:
receiving first prompt information returned by a server, the first prompt information indicating that the target virtual object is a virtual object that has been controlled by another viewer user; and
displaying the first prompt information.

9. The method according to claim 1, further comprising:
obtaining preference information of a viewer user based on user information of the viewer user, the viewer user comprising a user controlling the target virtual object or a user viewing the first live streaming resource; and
obtaining a target rendering form based on the preference information of the viewer user; and
the displaying the first live streaming resource comprises:
displaying the first live streaming resource in the target rendering form.

10. The method according to claim 1, wherein the method further comprises:
receiving second prompt information transmitted by a server, the second prompt information indicating that a difference between a control duration of the target virtual object and a use duration of the target virtual object is less than or equal to a duration threshold, the control duration being a duration for which the target virtual object has been controlled, and the use duration being a duration for which the target virtual object is allowed to be controlled; and
displaying the second prompt information.

11. The method according to claim 1, wherein the selectable virtual object is uncontrollable by the anchor user.

12. A virtual object control method, performed by a server, comprising:
receiving a control request transmitted by an electronic device, the control request carrying an object identifier of a target virtual object, the control request being for requesting to control the target virtual object, and the target virtual object being a selectable virtual object comprised in a first live streaming resource;
obtaining an audio and video data stream address of the target virtual object based on the object identifier of the target virtual object; and
transmitting the audio and video data stream address of the target virtual object to the electronic device.

13. The method according to claim 12, wherein the obtaining the audio and video data stream address of the target virtual object based on the object identifier of the target virtual object comprises:
determining an object state of the target virtual object based on the object identifier of the target virtual object; and
obtaining the audio and video data stream address of the target virtual object in response to the object state of the target virtual object being an uncontrolled state.

14. The method according to claim 12, wherein the method further comprises:
receiving a control instruction transmitted by the electronic device; and
transmitting the control instruction to a game client, the control instruction being for instructing the game client to control the target virtual object to perform a target operation.

15. The method according to claim 12, wherein the method further comprises:
receiving a live streaming resource acquisition request transmitted by the electronic device, the live streaming resource acquisition request carrying a live streaming studio identifier of a target live streaming studio;
parsing the live streaming resource acquisition request to obtain the live streaming studio identifier of the target live streaming studio;
obtaining the first live streaming resource from a game client based on the live streaming studio identifier of the target live streaming studio, wherein the first live streaming resource represent a game being played by an anchor user of the target live streaming studio using the game client; and
returning the first live streaming resource to the electronic device.

16. The method according to claim 13, further comprising:
transmitting first prompt information to the electronic device in response to the object state of the target virtual object being a controlled state, the first prompt information being for indicating that the target virtual object is a virtual object that has been controlled by another viewer user.

17. The method according to claim 12, wherein the first live streaming resource is for a cloud gaming, and the method further comprises:
rendering a game scene of the cloud gaming into a video and audio stream, and
transmitting the video and audio stream to the electronic device for display.

18. The method according to claim 12, wherein the method further comprises:
adjusting an object state of the target virtual object to a controlled state.

19. The method according to claim 17, wherein the object information of the target virtual object comprises a use duration and an object task, the use duration being a duration for which the target virtual object is allowed to be controlled, and the method further comprises:
obtaining a reward resource corresponding to the target virtual object in response to the object task of the target virtual object being completed within the use duration of the target virtual object; and
transmitting the reward resource corresponding to the target virtual object to the electronic device.

20. The method according to claim 12, further comprising:
transmitting second prompt information to the electronic device in response to a difference between a control duration of the target virtual object and a use duration of the target virtual object being less than or equal to a duration threshold, the second prompt information indicating that the difference between the control duration of the target virtual object and the use duration of the target virtual object is less than or equal to the duration threshold, the control duration being a duration for which the target virtual object has been controlled, and the use duration being a duration for which the target virtual object is allowed to be controlled; and
adjusting the object state of the target virtual object to an uncontrolled state.
